(19) United States
(12) Patent Application Publication
(10) Pub. No.: US 2007/0071882 A1
(43) Pub. Date: Mar. 29, 2007

(54) Flexible EL device and methods

(76) Inventors: Gary E. Thomas, Eindhoven (NL); Adrian H. Kitai, Mississauga (CA)

Correspondence Address: Ralph A. Dowell of DOWELL & DOWELL P.C., 2111 Eisenhower Ave, Suite 406, Alexandria, VA, 22314, US

(21) Appl. No.: 11/526,695

(22) Filed: Sep. 26, 2006

Related U.S. Application Data
(60) Provisional application No. 60/720,695, filed on Sep. 27, 2005.

(51) Int. Cl. B05D 5/06; B05C 5/00; B05B 13/02; B05B 7/16

(52) U.S. Cl. 427/64; 427/554; 427/212; 118/302; 118/305; 313/504

(57) ABSTRACT

A method of incorporating EL particles includes preparing target areas to receive EL particles and providing EL particles to the target areas. The method may include spot-heating target areas of a flexible substrate to form molten receiving areas adapted to receive an EL particle. EL particles may be provided to the target areas by a carrier tray or by a random process so that the EL particles adhere to the substrate at the target areas and form an EL apparatus. Pressure may be applied to embed the EL particles to a desired depth and top and bottom electrodes may be provided to the EL apparatus to form an EL display. A system for incorporating EL particles into a substrate may include a heat source adapted to spot-heat target areas and a carrier for providing EL particles to the target areas.

### CROSS-REFERENCE TO RELATED APPLICATIONS

This application claims priority benefit to co-pending U.S. Provisional Application No. 60/720,695 filed on Sep. 27, 2005, entitled Method For Transferring EL Spheres to Polymer Film, which is entirely incorporated herein by reference.

### FIELD OF THE INVENTION

The present invention relates to electroluminescent (EL) devices and methods for making such devices, and more particularly, to methods for incorporating EL particles into a substrate to form a flexible EL apparatus.

### BACKGROUND OF THE INVENTION

Thin film electroluminescent (TFEL) devices typically consist of a laminar stack of thin films deposited on an insulating substrate. These thin films may include a transparent electrode layer, an electroluminescent (EL) layered structure comprising an EL phosphor sandwiched between a pair of insulating layers, and a second electrode layer. In matrix-addressed TFEL panels the front and rear electrodes form orthogonal arrays of rows and columns to which voltages are applied by electronic drivers, so that light is emitted by the EL phosphor in the overlap area between the rows and columns when sufficient voltage is applied.

TFEL devices have the advantages of long life, wide operating temperature range, high contrast, wide viewing angle and high brightness. In designing an EL device, a number of requirements are imposed on the substrates, the laminate layers, and the interfaces between these layers. The dielectric constants of the insulator layers should be high to enhance electroluminescent performance. The combination of dielectric and electrode materials should support self-healing operation so that electric breakdowns are limited to small localized areas of the EL device. Only certain dielectric and electrode combinations have this self-healing characteristic. At the interface between the phosphor and insulator layers, material should be compatible to promote charge injection and charge trapping, and prevent the interdiffusion of atomic species during high temperature processing and/or high electric field operation.

Different EL thin film insulators are known, such as SiO₂, Si₃N₄, Al₂O₃, SiO_{X}N_{Y}, SiAlO_{X}N_{Y} and Ta₂O₅, typically referred to as low K dielectrics, having relative dielectric constants (K) in the range of 3 to 60. These dielectrics do not always provide optimum EL performance due to their relatively low dielectric constants. A second class of dielectrics, called high K dielectrics, offer higher EL performance. This class includes materials such as SrTiO₃, BaTiO₃, PbTiO₃ which have relative dielectric constants, generally in the range of 100 to 20,000, and are crystalline with perovskite structure. While all of these dielectrics exhibit a sufficiently high figure of merit (defined as the product of the breakdown electric field and the relative dielectric constant) to function in the presence of high electric fields, some of these materials do not offer sufficient chemical stability and compatibility in the presence of high processing temperatures that may be required to fabricate an EL device. Also, it is difficult to form high dielectric constant insulating layers as thin films with good breakdown protection.

As previously mentioned, substrates are of fundamental importance for TFEL devices. Glass substrates are commonly used in commercial production, but, at temperatures significantly higher than 500° C., glass softens and stresses within the glass may cause mechanical deformation. For this reason, the maximum processing temperature of a TFEL phosphor is of great significance as many TFEL phosphors require high processing temperatures. Although glass substrates may be considered for processing temperatures at which they soften, (generally above 500 to 600° C.), warping or compaction of the glass will occur, particularly if a long annealing time is required.

Substrates other than glass may be used, and Wu in U.S. Pat. No. 5,432,015 teaches the application of ceramic substrates such as alumina sheets for TFEL devices. In such devices, thick film, high dielectric constant dielectrics are prepared. Although these dielectrics offer good breakdown protection due to their thickness, they limit the processing temperature of phosphors that are on top of the dielectric layer, as phosphors that require high-temperature processing (700° C. or higher) may be contaminated by the dielectric formulation at these temperatures. Also, substrate cost is much higher for ceramics than for glass, particularly for large size ceramics over ˜30 cm in length or width, since cracking and warping of large ceramic sheets is hard to prevent or control.

There has been an increased interest in flexible polymer substrates for electronic displays due to their low cost, light weight and sturdiness. Flexible displays manufactured using a flexible substrate offer safety advantages by reducing glass-related injuries in some applications, such as their use in motor vehicles. Flexible substrates also offer the potential of flexible displays that can be folded or rolled into different shapes and sizes. The manufacture of displays using flexible substrates also offers the promise of roll-to-roll processing which is a low-cost volume-production method.

EL devices on plastic substrates are known in which a powder phosphor layer is deposited between two electrodes. These devices are known as powder EL devices and they are used in low brightness lamps and backlights for liquid crystal displays. Some powder EL lamps are based on ZnS:Cu (S. Chadha, Solid State Luminescence, A. H. Kitai, editor, Chapman and Hall, pp. 159-227). In these powders, Cu_{2-X}S forms inclusions, which act as electric field intensifiers since they are sharp-tipped conductors (tip radius ≦50 angstroms). During operation, however, these Cu_{2-X}S tips lose their sharpness, and the electric field decreases, resulting in weaker luminescence. In careful observation using an optical microscope, A. G. Fischer (A. G. Fischer, J. Electrochem. Soc., 118, 1396, 1971) saw comet-shaped light emission extending away from the tips, which decreased in length as the phosphor aged. Other reports (S. Roberts, J. Appl. Phys., 245, 1957) link deterioration of these phosphors to moisture and ion diffusion.

A recent breakthrough in the field of flexible EL devices is the development of Sphere-Supported-Thin-Film Electroluminescent (SSTFEL) devices. For example, PCT International Application No. PCT/CA2004/001592 filed on Sep. 3, 2004, and published as WO 2005/024951 A1, which is incorporated by reference herein in its entirety, discloses SSTFEL devices that include substantially spherical dielectric particles, such as spherical BaTiO₃ particles, and polymer substrates. Likewise, Yingwei Xiang, Adrian H. Kitai and Brian Cox have described in (Society for Information Display Conference, Boston, 2005, Paper P-8.2) an EL display concept in which spherical spray-dried BaTiO₃ particles are used as the starting material. After sintering and sieving, an oxide phosphor layer may be deposited and annealed on the top surface of mono-dispersed BaTiO₃ spheres. The phosphor-coated spheres may then be embedded into polypropylene film. This functional SSTFEL device may then be finished by depositing a front transparent ITO electrode and a rear gold electrode. Thus, electroluminescent display devices, capacitors, p-n semiconductor devices may be similarly produced.

Thus, by using this prior art process a thin film phosphor electroluminescent device can be prepared using dielectric spheres, such as BaTiO₃ spheres, for electroluminescent (EL) display applications. That process includes the use of spray drying techniques to produce spherical particles by atomizing a solution or slurry and evaporating moisture from the resulting droplets by suspending them in a hot gas. The spray drying process comprises four main steps: slurry preparation, atomization, evaporation and particle separation.

In the prior art fabrication process, these spherical spray-dried BaTiO₃ particles are sintered and embedded into a polypropylene film. FIG. 1 shows a schematic diagram of the structure of such a prior art Sphere-Supported Thin Film Electroluminescent (SSTFEL) device. A phosphor layer 4 may be deposited onto the top surface of BaTiO₃ spheres 3 and a thin SrTiO₃ layer 5 may be deposited onto the phosphor layer 4 for effective charge injection into the phosphor layer 4. The BaTiO₃ spheres 3 are embedded within a polymer layer 2 with the top and bottom areas of the BaTiO₃ spheres 3 exposed. The top area of the BaTiO₃ spheres 3 and the surrounding polymer may be coated with a transparent electrically conducting electrode 6; the bottom area of the BaTiO₃ spheres and surrounding polymer may be coated with another electrically conducting electrode 1, which may be opaque. Any EL phosphor material may be used, including but not limited to, metal oxide or sulfide based EL materials. For example, the sulfide phosphor may be any one of ZnS:Mn or BaAl₂S₄:Eu, or BaAl₄S₇:Eu. The oxide phosphors may preferably be any one of Zn₂Si_{0.5}Ge_{0.5}0₄:Mn, Zn₂SiO₄:Mn, or Ga₂O₃:Eu and CaAl₂O₄:Eu. Other exemplary phosphors are described in U.S. Pat. No. 5,725,801, U.S. Pat. No. 5,897,812, and PCT International Application No. PCT/CA2004/000527 filed Apr. 7, 2004 and published as WO 2004/090068 A1, which are incorporated by reference herein in their entirety. As shown in FIGS. 2A-2B, an exemplary prior art EL display 200 includes BaTiO₃ spheres 33 coated with a phosphor film 44 and embedded in a polypropylene film 22. A transparent top electrode 55 may be provided in spaced apart columns and a bottom gold electrode 11 provided in orthogonal spaced apart rows to form an EL display 200.

To embed the spheres 3 in the polypropylene sheet 2 a carrier tray transfer process is used. For example, in order to make a specific positional arrangement of BaTiO₃ spheres 3 embedded in the polypropylene film 2, a pattern of circular depressions or pits is used to hold BaTiO₃ spheres on a ceramic or alumina substrate during the sputtering, annealing and embedding processes.

To provide a sufficient bond for each BaTiO₃ sphere to stay in each pit, a polymer is melted into each pit. In order to keep the alumina surface between pits from being covered by polymer, solid poly PAMS powder may be used in the patterning process. At room temperature, solid poly (α-methylstyrene) PAMS powder is put into each pit so that there is little PAMS powder on the surface area between pits. Then, still at room temperature, BaTiO₃ spheres are spread onto the Al₂O₃ plate to form one layer of a closed packed pattern. After increasing the temperature to ˜115° C., the PAMS powder in each pit melts to form an adhesive gel. When BaTiO₃ spheres are pressed gently, one sphere adheres to each pit. After cooling to room temperature, excess BaTiO₃ spheres are brushed away, leaving the same pattern of spheres as that of pits.

After patterning, the Al₂O₃ plate loaded with BaTiO₃ spheres is baked in air to burn off the PAMS completely. After baking, the spheres are still weakly adhered to the Al₂O₃ plate due to weak bonding forces that result from the burn-off of PAMS. The sticky force is large enough to keep the spheres stationary during the following sputtering, annealing and embedding processes.

A 50 nm thick Al₂O₃ barrier layer may be deposited on the top area of BT spheres by RF sputtering, followed by a phosphor layer, such as green emitting Zn₂Si_{0.5}Ge_{0.5}0₄:Mn. The spheres may be kept at 250° C. and the EL film may have a thickness of about 800 nm. After sputtering, the spheres, still sitting on the Al₂O₃ plate, may be annealed at 800° C. for 12 hours in vacuum with an oxygen pressure of 2.0×10⁴ Torr. This annealing procedure is to activate and crystallize the phosphor layer. The Al₂O₃ barrier layer improves the phosphor performance since it acts as a diffusion barrier between the BT and the phosphor.

As shown in FIGS. 3A-3D, after annealing, to embed phosphor-coated BaTiO₃ 3 spheres into a polypropylene film 2, the polypropylene film 2 is placed over the phosphor-coated BT spheres 3. Then a Gel-Pak sheet 8 which comprises an elastic, gel-like, adhesive polymer layer supported by a polyester sheet is placed on the top of the polypropylene film 2 (FIG. 3A). A pressure is applied on the back of polyester sheet to hold the structure together. After heating the whole structure, the polypropylene film 2 melts and fills in between the spheres under the pressure (FIG. 3B). After cooling, a polypropylene-BT composite sheet is peeled off. Next, this composite sheet may be sandwiched between two Gel-Pak sheets 8 (FIG. 3C). The composite sheet is heated and melted again under pressure so that the polypropylene moves to the center of the composite sheet away from so that the top and bottom areas of the spheres 3 are not covered by polypropylene film. After the resultant film is obtained, electrode layers may be sputtered onto the bottom and top areas of the film to produce an EL display.

While this prior art method of providing EL spheres to a substrate is fit for its intended purpose, it has several disadvantages. For example, the process requires several heating steps. In addition, the heating of the entire substrate can deform the substrate. Furthermore, the use of a carrier tray is complicated and time consuming, and limits the arrangement of the EL spheres in the polymer to the arrangements of the pits in the tray.

### SUMMARY OF THE INVENTION

The present invention provides methods and systems for incorporating EL particles into a substrate to form a flexible EL apparatus. In broad terms, a method of the invention includes preparing a target area of a substrate to receive an EL particle and incorporating the EL particle into the target area. In the exemplary embodiments of the invention, methods include locally heating target areas of a flexible substrate so that the target areas form molten receiving areas, and providing EL particles to the molten receiving areas so that the EL particles attach to the substrate. Pressure may be applied to embed the EL particles to a desired depth in the substrate. A system of the invention may comprise a substrate preparation device adapted to prepare a target area of a substrate to receive an EL particle; and an EL particle carrier, adapted to provide an EL particle to the target area.

In one exemplary method of the invention, a carrier tray is used to provide a desired arrangement of EL particles to the target areas. For example, target areas of a polymer substrate may be locally heated at locations corresponding to the locations of the EL particles on a carrier tray. The heated target areas become molten so that they are adapted to receive an EL particle. The substrate and carrier tray are aligned so that molten target areas, or receiving areas, are aligned with the EL particles of the carrier tray. The substrate and the carrier tray may be pressed together so that the EL particles of the carrier tray contact and adhere to the target molten areas. The EL particles may be embedded in the polymer substrate to a desired depth by applying a specified pressure. As the molten areas cool and return to solid form, the EL particles are retained in the polymer substrate to form a flexible EL apparatus. Column and row electrodes may then be provided to the EL apparatus to form an EL display.

In another exemplary embodiment, the EL particles are provided to spot-heated target areas of a polymer by dropping the EL particles on the polymer. The EL particles may be provided by various means such as, by way of example and not limitation, pouring them from a container, carrying them on an air stream, or providing them on a roll. For example, a plurality of target areas may be locally heated in a polymer substrate by a laser so that the target areas become molten. EL particles may then be poured onto the polymer substrate from a container so that some of the EL particles contact the molten target areas (receiving areas) and adhere to the molten material so that they are retained by the polymer substrate. EL particles that do not contact the molten target areas do not adhere to the polymer substrate and, therefore, are not retained. These non-adhered particles can be removed from the polymer substrate and collected for later use. For example, they can be brushed or blown off the substrate and captured in a container. An advantage of this embodiment is that it eliminates the difficulties and limitations associated with the use of a carrier tray. Furthermore, a wide variety of EL particle patterns may be achieved by changing the location of the heated target areas by simply reprogramming the laser.

The present invention may employ a roll processing system. For example, a polymer substrate may be provided in a continuous roll of material. A first section of the substrate may be unrolled and processed to incorporate EL particles as discussed above. Another section of the substrate could then be unrolled and the process repeated to incorporate EL particles in the second section. This process can be repeated numerous times to form a flexible EL apparatus of a desired continuous length.

The present invention allows for a variety of different patterns of EL particles to be incorporated into a flexible substrate including arrangements of EL particles having desired characteristics, such as phosphor color. For example, where an RGB (red, green, blue) pixel arrangement is desired, the phosphor-coated EL particles corresponding to each color may be located and incorporated into the substrate. For example, target areas associated with the desired location of red phosphor EL particles in the polymer may be heated to produce molten receiving areas and red-coated EL particles provided to the molten receiving areas. To incorporate green-colored EL particles, target areas associated with desired locations of green-coated phosphor EL particles may then be spot heated to provide second molten receiving areas. Green phosphor-coated EL particles may then be provided to the second molten receiving areas. This process may then be repeated for blue phosphor-coated spheres so that a desired arrangement of red, green and blue EL particles is incorporated into the flexible substrate to form a desired pattern. Alternatively, to achieve a random pattern, target areas may be heated and red, green and blue EL particles poured onto the substrate in a random fashion.

The present invention provides means to avoid the multistep heating process of the prior art method described above, as well as the need to heat the entire polymer substrate. In addition, it avoids the EL particle arrangement limitations intrinsic to use of a carrier tray. The method is also sufficiently reliable and high-speed to produce sufficient throughput for industrial scale applications. In addition, the method can produce desired RGB pixel structures or other arrangements suitable for EL display applications. Because the polymer substrate is not subjected to overall heating its structural integrity is preserved so as to facilitate the accurate transfer of the phosphor-coated EL particles to provide a desired pixel arrangement.

An exemplary embodiment of a system of the invention includes a substrate preparation device in the form of a laser that is adapted to heat target areas of a substrate to form molten EL receiving areas adapted to receive an EL particle. Exemplary embodiments of the system of the invention also include EL particle carriers in the form of a carrier tray, a container, and a flow carrier. The system may also include pressure means for embedding EL particles in a substrate to a desired depth.

### BRIEF DESCRIPTION OF THE DRAWINGS

The invention will now be described, by way of example only, reference being had to the accompanying drawings, in which:

FIG. 1 shows a schematic diagram of a prior art SSTFEL structure;

FIG. 2A shows a side view of a prior art SSTFEL structure;

FIG. 2B shows a top plan view of the prior art SSTFEL structure of FIG. 2A;

FIGS. 3A-3D show a prior art method of embedding BaTiO₃ spheres in a polymer;

FIG. 4 shows a flow chart of a method in accordance with an exemplary embodiment of the invention;

FIG. 5 shows a flow chart of a method in accordance with an exemplary embodiment of the invention;

FIG. 6 shows a system for incorporating an EL particle into a substrate in accordance with an exemplary embodiment of the invention;

FIGS. 7A-7H show a method of incorporating EL particles into a substrate in accordance with an exemplary embodiment of the invention;

FIGS. 8A-8C show a system for roll-processing in accordance with an exemplary embodiment of the invention;

FIG. 9 shows a flow chart of an exemplary method of the invention;

FIGS. 10A-10F show a method of incorporating EL particles into a substrate in accordance with an exemplary embodiment of the invention;

FIG. 11 shows a flow chart of an exemplary method of the invention; and

FIGS. 12A-12N show a method of incorporating EL particles into a substrate in accordance with an exemplary embodiment of the invention.

### DETAILED DESCRIPTION

Generally speaking, the systems and methods described herein are directed to incorporating EL particles in a flexible substrate to form a flexible EL apparatus. As required, embodiments of the present invention are disclosed herein. However, the disclosed embodiments are merely exemplary, and it should be understood that the invention may be embodied in many various and alternative forms. The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to an EL apparatus that may be used to form a display.

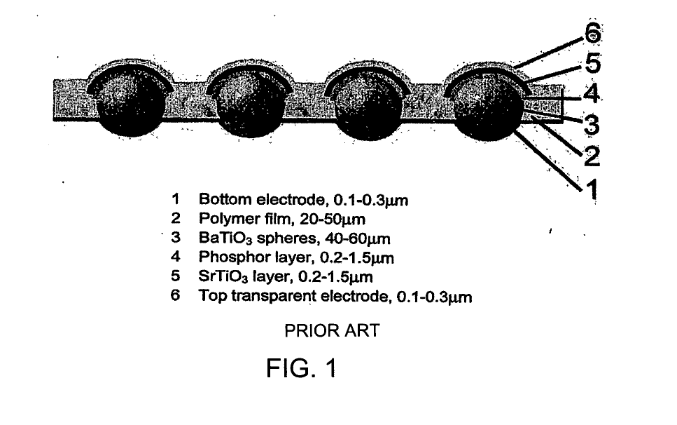

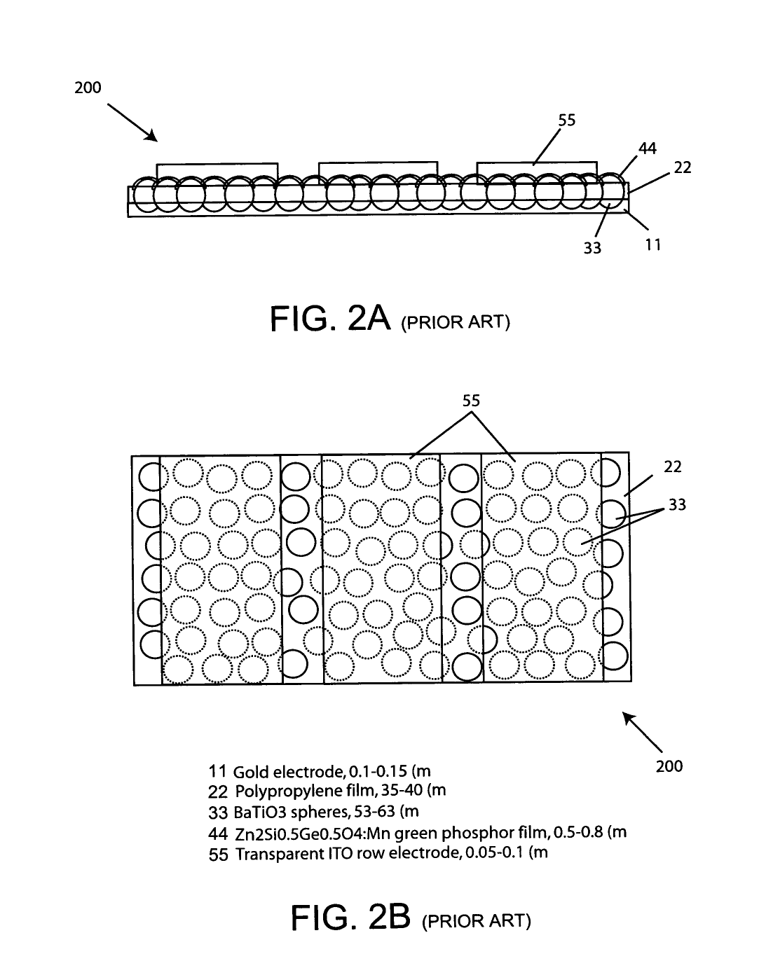

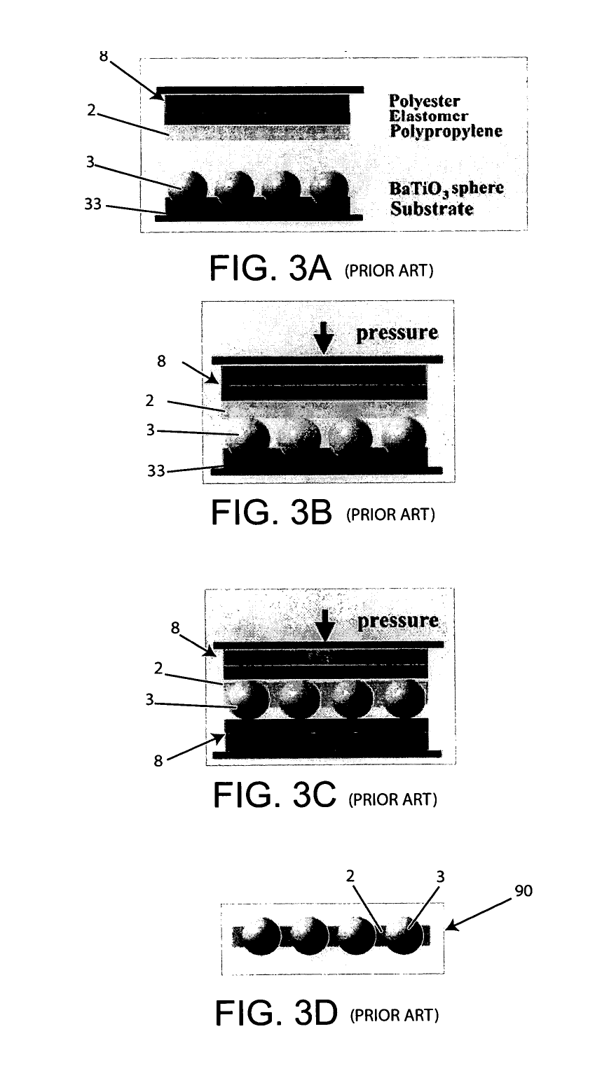

The term EL particle as used herein is meant to include a solid dielectric material having a phosphor coating. The EL particle may be of various shapes and sizes. For example, an EL particle may take the form of BaTiO₃ spheres as disclosed in FIGS. 1 and 2A-2B. It should be noted that while in the exemplary embodiments discussed herein the EL particles are shown as spherical in shape, it is contemplated that other shaped particles could be used, such as cylindrical, conical, or prismatic. In addition, it is contemplated that the EL particle may be partially coated or entirely coated by a phosphor layer. For example, BaTiO₃ spheres may be prepared in carrier trays and coated with a phosphor layer as described above. On the other hand, EL particles may be wholly coated by a phosphor layer so that the orientation of the EL particle when incorporated into a substrate is immaterial. It is also contemplated that the EL particles may be of other shapes and that the molten areas created in accordance with the invention may be generated in shapes desirable for receiving the EL particles. It is also contemplated that the EL particle may have additional layers such as additional charge injection and conductive layers. These additional layers may assist in the function of an EL display.

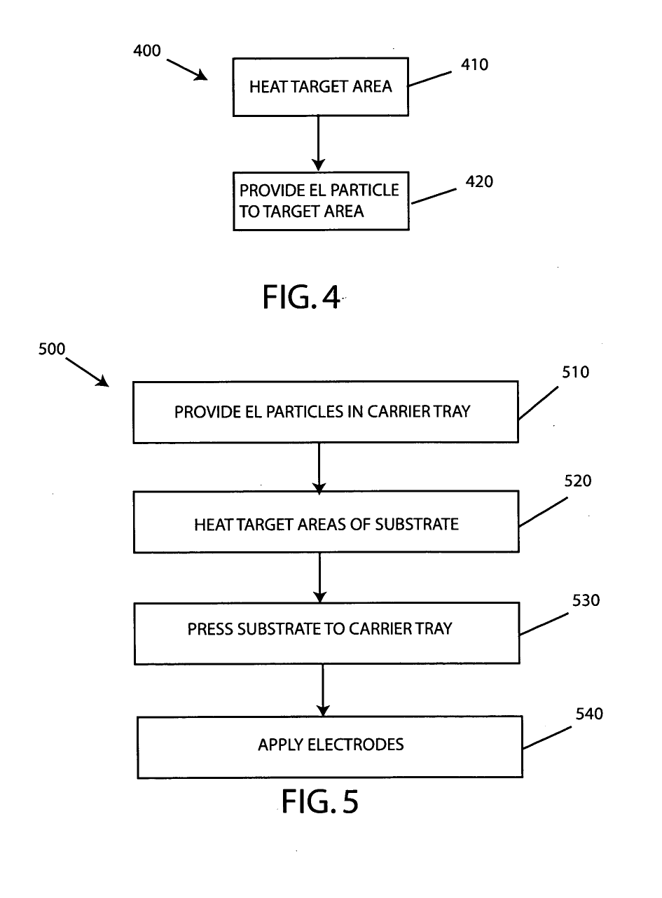

Referring now to the drawings, wherein like numerals represent like elements throughout, FIG. 4 shows a flow chart of an exemplary method 400 of the invention. At block 410 a target area of a flexible substrate is heated so that the target area becomes melt to become a molten receiving area. At block 420 an EL particle is provided to the molten receiving area so that the EL particle attaches to the substrate to form an EL apparatus.

FIG. 5 shows a flow chart of an exemplary method 500 of making a flexible EL display in accordance with the invention. At block 510 an EL particle is prepared. For example, as discussed above, a spray drying and sputtering process may be used to produce an EL particle in the form of a phosphor-coated BaTiO₃ dielectric sphere. As previously mentioned, the EL particle may take a variety of forms but is shown in the exemplary embodiments as a spherical solid dielectric with a phosphor coating. At block 520 target areas of a flexible polymer substrate are heated to become molten and at block 530 EL particles are provided to the molten target areas to form an EL apparatus. At block 540 electrodes may be provided to the EL apparatus to form an EL display. For example, a transparent top electrode and a bottom electrode may be added to the EL apparatus in orthogonal rows and columns to form a matrix-addressed EL display as shown in FIG. 2.

In the exemplary embodiments discussed herein, the flexible substrate in which the EL particles are incorporated is shown as a thin polymer film, such as polypropylene. It is contemplated however that the substrate may take a variety of forms. In the exemplary embodiments shown, the polymer substrate is made of a material that when heated becomes sufficiently molten without becoming brittle upon cooling. The polymer substrate may also be doped with an absorbing dye, such as, by way of example and not limitation, a dye that absorbs light in the visible wavelength so that contrast ratio of the EL display is increased. The polymer film may be locally heated or, as also referred to herein, spot-heated, by a heat source at desired target locations. For example, a single spot laser or a multi-spot laser scanner of sufficient resolution and precision may be used to provide a single or multiple focused beams to a target area or areas, respectively. In one embodiment, the process may be carried out in a planar geometry in which a carrier tray containing EL particles is provided on a precision x-y table and a polymer substrate is transported above the carrier. The polymer substrate and carrier tray can thus be arranged so that the EL particles in the carrier tray are aligned with the target areas of the polymer substrate. Because the polymer substrate is flexible, a roll-type process using a continuous rolled polymer substrate may be implemented. In general, roll-type processes can achieve higher throughput speeds in a more compact footprint thereby providing a cost effective manufacturing method.

In an exemplary embodiment, a laser is used to raise the temperature of the polymer substrate at desired target locations to a threshold temperature at which the polymer is sufficiently molten to allow for the embedding of EL particles under a predetermined pressure. Infra-red or near infra-red laser diodes may be used to provide a high power and low cost light source. A thermal or photonic process may be used. The heating process may include the scanning of a laser beam in raster fashion and may include the use of multiple heads. For example a thermal head with an IR or near IR laser diode may be used.

This process may greatly increase the temperature at the selected target areas of the polymer substrate. However, because the heat is localized to the desired areas for a short period of time, overall heating, thermal expansion, and deformation of the entire polymer substrate are avoided. This allows the polymer substrate to maintain its form while specific localized areas to which the EL particles will be provided become sufficiently molten so as to accept the EL particles. Thus, the EL particles may be embedded into the polymer substrate in an accurate arrangement in accordance with a desired arrangement or pixel pattern. The degree to which the localized areas become molten may be determined by the type and thickness of the polymer being used and the depth to which the EL particles will be embedded in the polymer. A variety of different EL particles arrangements may be generated with the present invention and the laser source may be programmed in accordance with the desired arrangement of EL particles. For example, the EL particles may be provided in various groupings and patterns with a variety of colors.

In an exemplary embodiment that employs the use of a carrier tray, the process may be performed in a planar geometry using a flatbed machine and x-y table. For example, a carrier tray of EL particles may be loaded onto a flatbed chuck and held down by a vacuum system. The polymer substrate may be placed above the carrier tray such as by a second vacuum system. A laser source may then heat the localized areas of the polymer substrate in accordance with a desired transfer procedure so that desired localized areas become molten. For example, the areas of the polymer substrate corresponding to the desired location of green phosphor coated EL particles may be heated by the laser so that the green EL particles are embedded in the polymer substrate at desired locations.

Pressure may be applied so that the green EL particles are embedded in the polymer substrate to a desired depth. This process may be repeated for other EL particles having different colored phosphor coatings to establish a desired pattern such as a desired RGB pixel pattern for a color display. The x-y table allows for the accurate positioning of the polymer substrate to the carrier tray. Because the polymer substrate is not deformed by the spot-heating, the polymer substrate retains its shape allowing for multiple spot heatings of the polymer with accurate positioning of the EL particles in the polymer substrate. Additional pressure, supplied, for example, by a pressure plate, and/or heat may be applied to embed the EL particles at a desired depth. The laser source can quickly and accurately heat a desired target location of the polymer substrate, thereby obviating the need to heat the entire polymer substrate and carrier tray as in the prior art and decreasing heating time. Because the polymer substrate is flexible, in an alternative embodiment a drum machine thermal imaging unit may be used to transfer the spheres to the polymer. Typically, drum machines are priced lower and produce higher throughput than flatbed machines.

In another embodiment, EL particles having different phosphor coatings may be embedded simultaneously. For example, localized areas of the polymer substrate may be heated which correspond to different phosphor coated EL particles such as red, green and blue on a carrier tray, so that multiple EL particles of different phosphor colors may be embedded in the polymer together.

In an exemplary method employing a roll type process, the polymer substrate may be unrolled, heated and placed over the carrier tray. For example, as it is unrolled from a rolled up condition, one or more rows of the polymer substrate may be heated at locations corresponding to the EL particle locations. The heated polymer substrate portion may be placed in contact with the EL particles so that a row or rows of the EL particles is embedded in the polymer substrate and pressure may be applied. Because the polymer substrate may be arranged in a rolled condition, less space is needed for the process. In addition, a continuous length of an EL apparatus can be produced.

EL particles having different characteristics, such as different color phosphor coatings, may be incorporated into the substrate. In one embodiment, EL particles of different phosphor colors may be embedded at the same time from a single carrier tray. For example, red, green and blue phosphor coated EL particles are arranged in the carrier tray in a desired pixel formation, the polymer substrate target areas melted, and the red, green, and blue phosphor-coated EL particles embedded in one step. In another embodiment, multiple carrier trays may be used. For example, a carrier tray with red phosphor coated EL particles, a carrier tray with green phosphor-coated EL particles, and a carrier tray with blue phosphor-coated EL particles may be provided and different colored EL particles incorporated sequentially by tray.

In other embodiments of the invention, a carrier tray is not used; Instead, EL particles are provided in a “random” process whereby a particular EL particle is not assigned to a particular target area. For example, target areas may be heated to become molten and a plurality EL particles provided by various random means such as by pouring the EL particles from a container, carrying the EL particles on an air stream, or shaking from a vibrating table. By heating multiple target areas and providing a plurality of EL particles, some of the EL particles will contact molten target areas and attach to the polymer substrate, and thereby be retained. EL particles that do not contact a molten area do not attach to the polymer. The non-attached EL particles may be removed and collected for later use. Where the EL particles of a desired pattern have the same characteristics, a plurality of those EL particles can be provided to the target areas. Where it is desired to arrange EL particles according to particular characteristics, a sequence of incorporations may be employed. For example, a first set of target areas associated with desired locations of EL particles with a first characteristic may be heated and EL particles having that first characteristic may be provided to these first molten target areas. A second set of target areas associated with locations of EL particles having a second characteristic may then be heated and a second group of EL particles having the second characteristic provided to the second molten target areas. This process may be repeated so that target areas are prepared for EL particles having particular desired characteristics, and associated EL particles are provided.

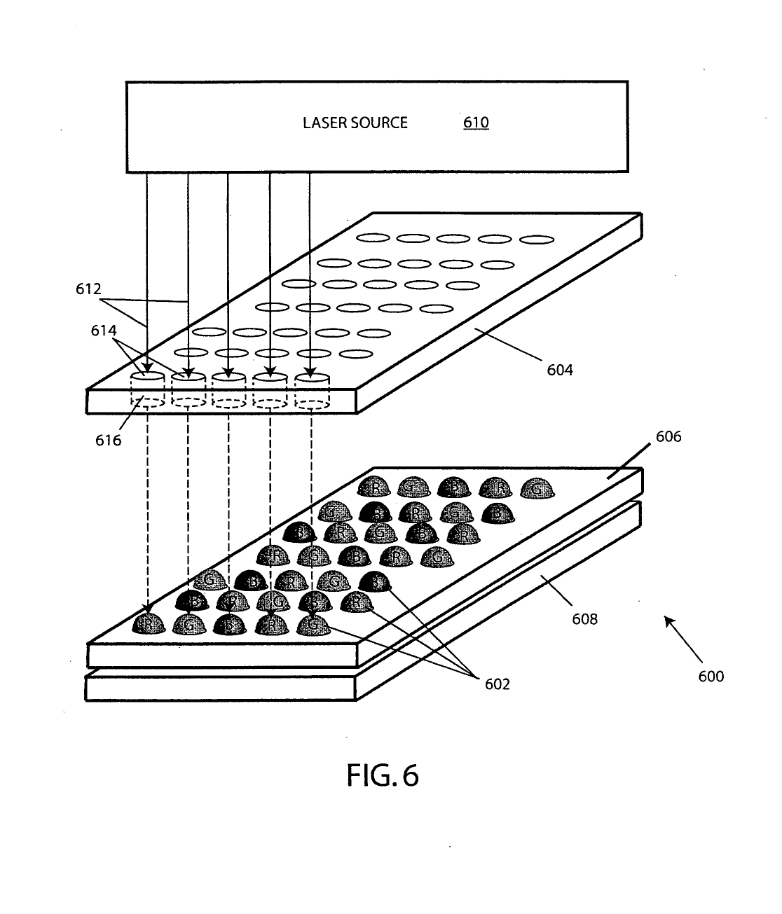

FIG. 6 shows an exemplary embodiment of a system 600 of the invention used for incorporating EL particles 602 into a polymer substrate 604. The system 600 includes a spot-heating source in the form of a laser 610 and an EL particle provider in the form of a carrier tray 606 having a plurality of EL particles 602 arranged in a predetermined pattern. For example, the pattern may correspond to a preferred pixel arrangement for a color display. The carrier tray 606 is provided on an x-y table 608 to allow for the precise positioning of the carrier tray 606 relative to the polymer substrate 604. A variety of different EL particle arrangements may be used. In this example, red, green and blue phosphor-coated sphere-shaped EL particles 602 shown as R, G, or B may be provided on the carrier tray 606. A laser source 610, such as a laser diode device, emits one or more laser beams 612 to heat specified target areas 614 of a polymer substrate 604 corresponding to desired positions of EL particles 602. For example, a linearly scanning single spot laser or a multispot laser may be used to generate molten EL particle receiving areas 616. The target areas 614 become molten so that when the polymer substrate 604 is moved into contact with the EL particles 602, the EL particles 602 corresponding to the molten areas become embedded in the polymer substrate 604. EL particles 602 corresponding to areas of the polymer substrate 604 that are not heated do not become embedded as those portions of the polymer substrate are not sufficiently heated to become molten. Thus, while the target areas 614 are locally heated to produce EL particle receiving areas 616, the rest of the polymer substrate 604 maintains its form. While in the exemplary embodiment discussed above the carrier tray 606 was placed on an x-y table it is contemplated that other machinery could be used to accomplish the method. For example, an x-y-z table could be employed to move the carrier tray to the polymer substrate.

As mentioned above, the target areas 614 are raised to a desired threshold temperature to allow for the proper heating of the polymer substrate to provide EL particle 602 receiving areas 616 of molten polymer. The extent to which the target areas 614 becomes molten depends upon a variety of factors such as the composition and thickness of the polymer substrate 604, the size of the EL particles 602 that are to be incorporated into the polymer substrate 604, the desired depth to which the EL particles 602 will be embedded, the amount of pressure applied to the polymer substrate, and other factors. The laser source 610 may be adjusted according to the desired parameters by varying the power, wavelength and photonic flux of the laser. The polymer substrate may also be doped with an absorbing dye to increase contrast ratio or decrease incident light reflection. The amount of pressure applied may also be adjusted. Whereas in the discussion above the polymer substrate 604 was heated prior to contact with the EL particles 602, the polymer substrate 604 may be heated during contact or subsequent to contact with the EL particles 602. A specified amount of pressure may also be supplied to embed the EL particles 602 to a desired depth. Because only the specified areas are heated, the selected portions of the polymer substrate quickly cool so that the EL particles 602 are embedded into the polymer substrate 604.

It is contemplated that the arrangement of the EL particles 602 in a carrier tray may be varied and the target areas of the polymer substrate 604 adjusted accordingly. For example, various different colors, spacing, and groupings of EL particles 602 may be used to produce desired pixel arrangements for an EL display. While in FIG. 6, red, green, and blue EL particles 602 are shown in the carrier tray 606 it is contemplated that EL particles 602 of a single color or additional colors may be provided.

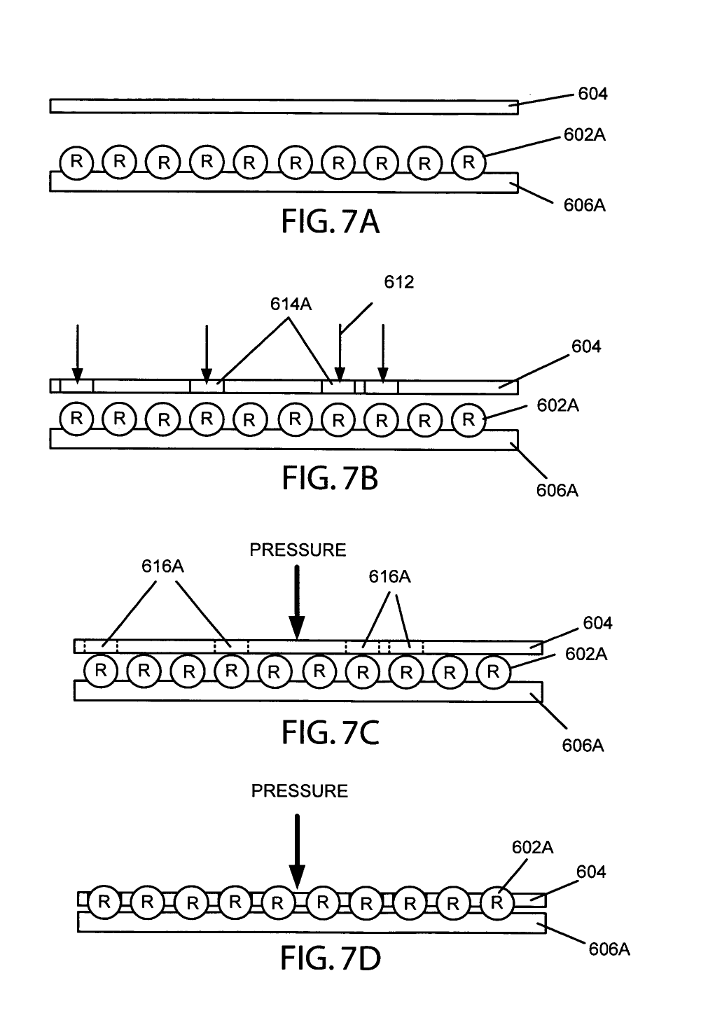

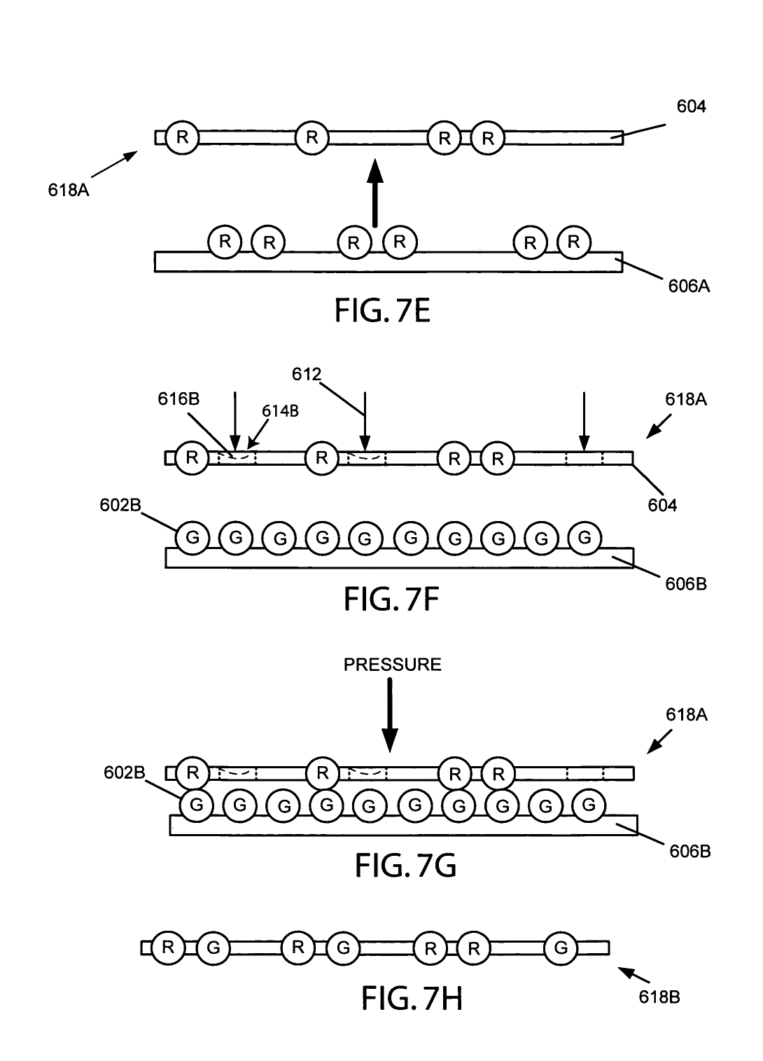

In the embodiment shown in FIG. 6 a single carrier tray 606 was used and all of the EL particles 602 on the carrier tray 606 were embedded into the polymer substrate 604. It is contemplated, however, that specific target locations may be prepared so that some but not all of the EL particles 602 in the carrier tray 606 are embedded. It is also contemplated that multiple carrier trays 606 and a series of embedding processes may be used to incorporate EL particles 602 having desired characteristics into specified locations of a polymer substrate 604. For example, FIGS. 7A-7H show a side view of an exemplary embodiment of a process of the invention in which EL particles 602 are embedded into a polymer substrate 604 in accordance with particular desired characteristics.

As shown in FIG. 7A a polymer substrate 604, such as a polypropylene film, is provided above a first carrier tray 606A having a plurality of depressions or dips for supporting first EL particles 602A having a first desired characteristic, such as red phosphor coating. In FIG. 7B a laser source (not shown) provides a laser beams 612 to one or more target areas 614A on the polymer substrate 604 that correspond to the desired location of the red phosphor-coated EL particles 602A within the polymer substrate 604. These target areas 614A become molten to form EL particle receiving areas 616A that are adapted to receive and retain EL particles 602A with which they come into contact.

As shown in FIG. 7C-7D the polymer substrate 604 may be moved downward so that it contacts the red phosphor-coated EL particles 602A under a predetermined pressure so that the molten areas 616A are aligned with red phosphor-coated EL particles 602A. In the illustrated embodiment the polymer substrate 604 is moved down to carrier tray 606A. However, as discussed above, the particular arrangement for contacting the EL particles 602A with the polymer substrate may vary. The red phosphor-coated EL particles 602A that are aligned with the molten areas 616A become embedded in the polymer substrate 604 at the designated molten areas 616A as shown in FIG. 7D. As the molten areas 616A cool, the polymer substrate 604 may be moved away from the carrier tray 606A, as shown in FIG. 7E, with the red phosphor coated EL particles 602A embedded in the polymer substrate 604. The polymer substrate 604 incorporating the EL particles 602A defines an EL apparatus 618A. Note that the EL particles 602A that correspond to areas of the polymer substrate 604 which were not heated are not embedded in the polymer substrate 604 but remain in the carrier tray 606A.

Additional EL particles 602A having other desired properties may then be embedded into the polymer substrate 604 in specified locations by repeating the above process. For example, as shown in FIG. 7F, a second carrier tray 606B may be provided in which a second set of EL particles 602B having a second desired characteristic are provided. In this example, the desired characteristic is a green-phosphor coating. A second set of target areas 614B corresponding to the desired location of the green phosphor coated EL particles 602B in the polymer substrate 604 may be excited by the laser to generate molten areas 616B for embedding the green phosphor-coated EL particles 602B. As shown in FIG. 7G-7H the polymer substrate 604 may be moved downward so that it contacts the green phosphor-coated EL particles 602B under a predetermined pressure so that the molten areas 616B are aligned with green phosphor-coated EL particles 602B. The green phosphor-coated EL particles 602B that are aligned with the molten areas 616B become embedded in the polymer substrate 604 at the designated molten areas 616B as shown in FIG. 7H to form an EL apparatus 618B. This process allows a user to provide different carrier trays 606, with each carrier tray 606 providing EL particles 602 having a particular desired characteristic, such as a desired phosphor color, and alleviates the need of having to accurately arrange the particular EL particles 602 in the carrier tray 606. Instead, the heat source can be instructed to prepare molten areas 616 in the polymer substrate to correspond to the desired embedding locations of the particular EL particles on the tray.

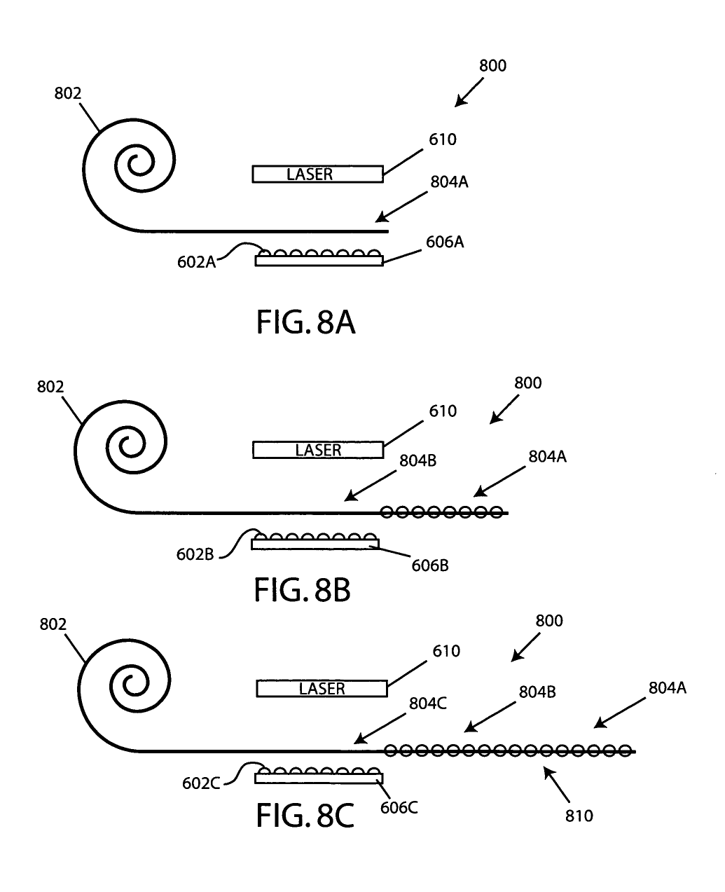

Another advantage of the present invention is its adaptability to roll-type processing. Due to the use of targeted heating techniques, the polymer substrate of the present invention largely retains its integrity/shape and portions of a continuous film can be processed in individual sections. For example, as shown in FIG. 8A a system 800 is shown in which a polymer substrate may be provided in a continuous roll 802. A first section 804A of the roll 802 may be processed as discussed above using a laser source 610 and a first carrier tray 606A to embed EL particles 602A in the first section 804A. As shown in FIG. 8B, a second section 804B of the polymer substrate may then be processed to embed EL particles 602B provided on a second carrier tray 606B. As discussed above, multiple carrier trays 606 may be used for embedding EL particles 602 in each section 804 of the polymer. This process may again be repeated to embed EL particles 602C from a third carrier tray 606C into a third section 804C of the roll 802. By this process, an EL apparatus 810 of a continuous length can be provided. This EL apparatus 810 may be cut into shorter lengths or combined with addition EL apparatus in forming a larger EL apparatus of a desired size.

Whereas the exemplary embodiments discussed above employ a carrier tray 606 to hold EL particles 602 for embedding into a substrate, it is contemplated that other methods could be used to provide the EL particles 602 that obviate the need to closely align the substrate with the carrier tray 606.

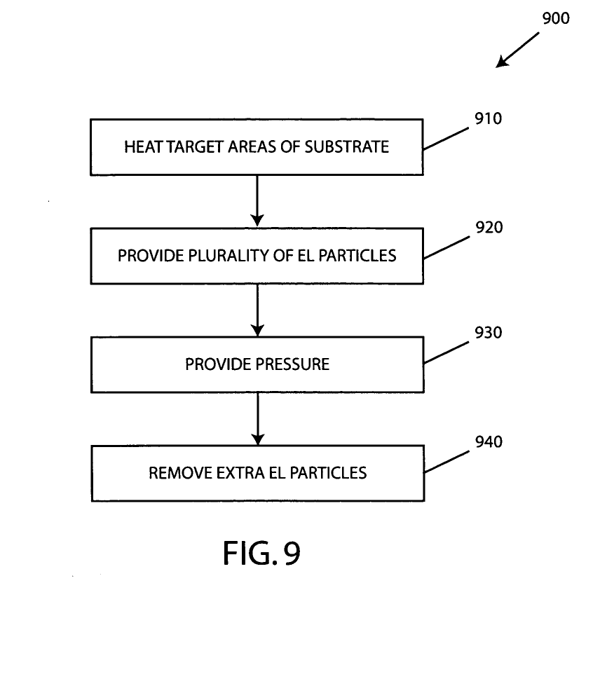

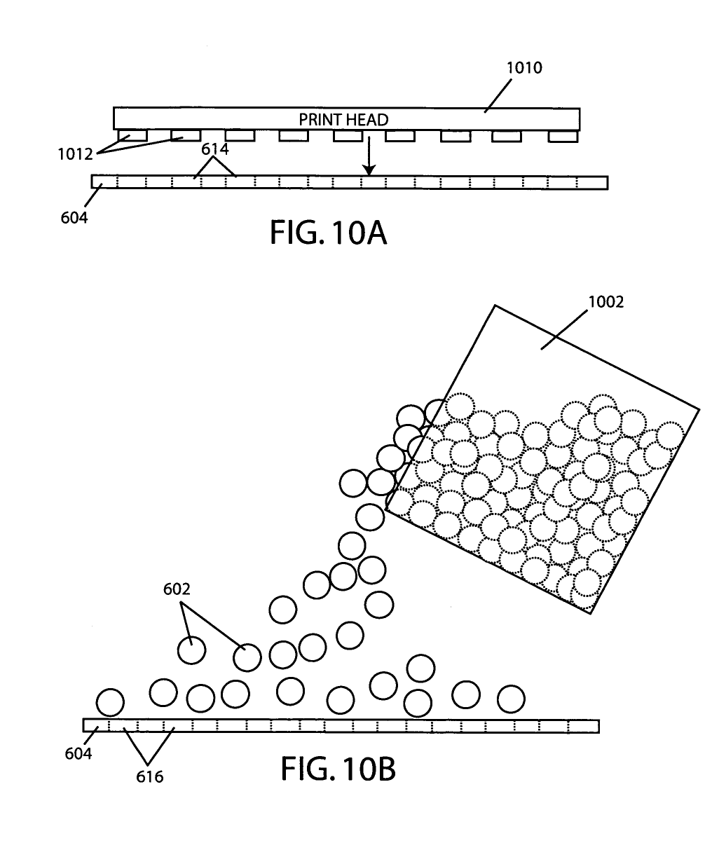

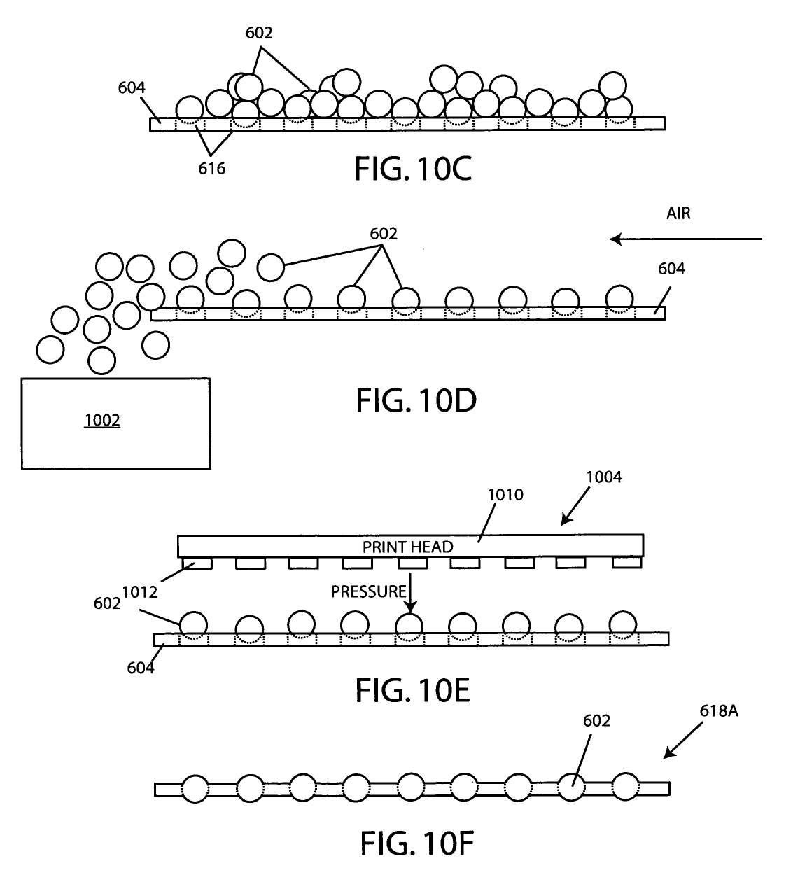

FIGS. 9 and 10A-10B show another exemplary method of the invention which obviates the use of a carrier tray by heating the polymer and providing the EL particles to the polymer in a random fashion. Instead of aligning molten target areas of a polymer substrate with EL particles provided in a carrier tray, a plurality of EL particles may be poured, blown, or otherwise provided to molten receiving areas. EL particles which contact the molten areas become attached to the polymer and EL particles that do not contact the molten areas may be collected for later use. This allows the EL particles to be provided to the polymer in a random manner without the need of assigning a particular EL particle to a particular receiving area. If it is desired that all of the EL particles to be embedded in the substrate have the same characteristics, then a large number of this type of EL particle may be provided, as the location of any particular EL particle in any particular target area is not of concern. If it is desirable to arrange EL particles in particular patterns or arrangements according to the particular EL particles characteristics, such as by phosphor color, then a series of embedding steps may be performed to obtain the desired arrangement.

As shown at block 910 of method 900 in FIG. 9, a plurality of target areas 614 of a polymer substrate 604 may be heated to form molten EL particle receiving areas 616 (FIG. 10A) adapted to receive EL particles 602. In this embodiment, the spot-heating source is in the form of a thermal printhead 1010 having a plurality of heating elements 1012 for spot heating the target areas 614. Thermal printheads are available from a variety of manufacturers such as Kyocera and Toshiba and typically comprise a line of heat elements 1012 formed of resistors that are capable of producing precisely controlled heat spots in a material. Thermal print heads are typically used in conjunction with a layer of ribbon or other material that is to be adhered to a substrate, such as paper. For example, a ribbon layer may be heated and pressed on to paper so that the heated portion of the ribbon layer adheres to the substrate. Thus, as shown below, a thermal printhead 1010 may be adapted to provide both heat and pressure to the target areas 614 to make the target areas 614 molten and embed the EL particles.

At block 920 a plurality of EL particles 602 are provided to the polymer substrate 604. In this case, it is may be preferable to use EL particles 602 that are wholly coated with a phosphor layer so that the orientation of the EL particles 602 within the polymer substrate 604 is of no consequence so that a portion of the EL particle 602 extending from the polymer substrate 604 has a phosphor layer 4. This may be accomplished by known sputtering techniques described above. This phosphor coated portion protrudes from the top of the polymer substrate 604.

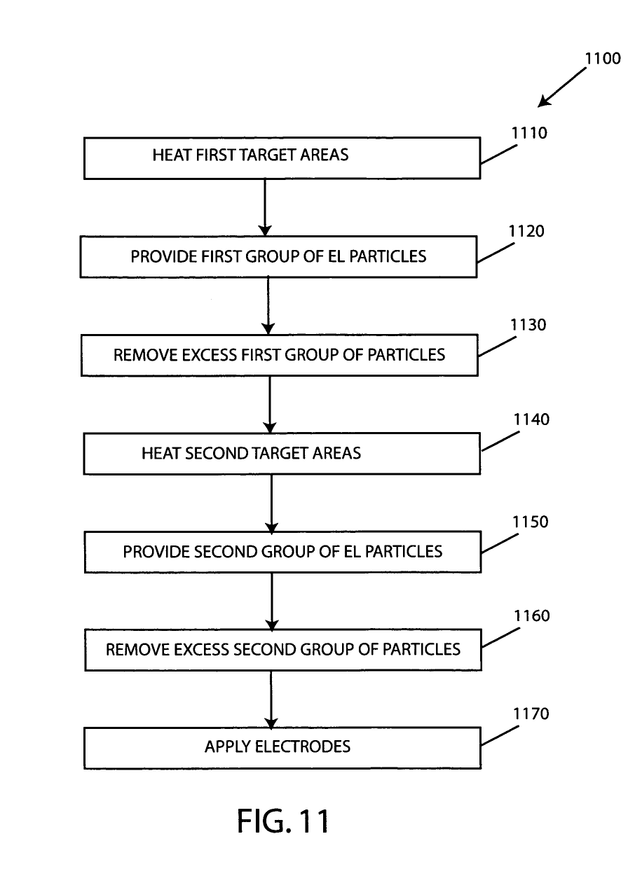

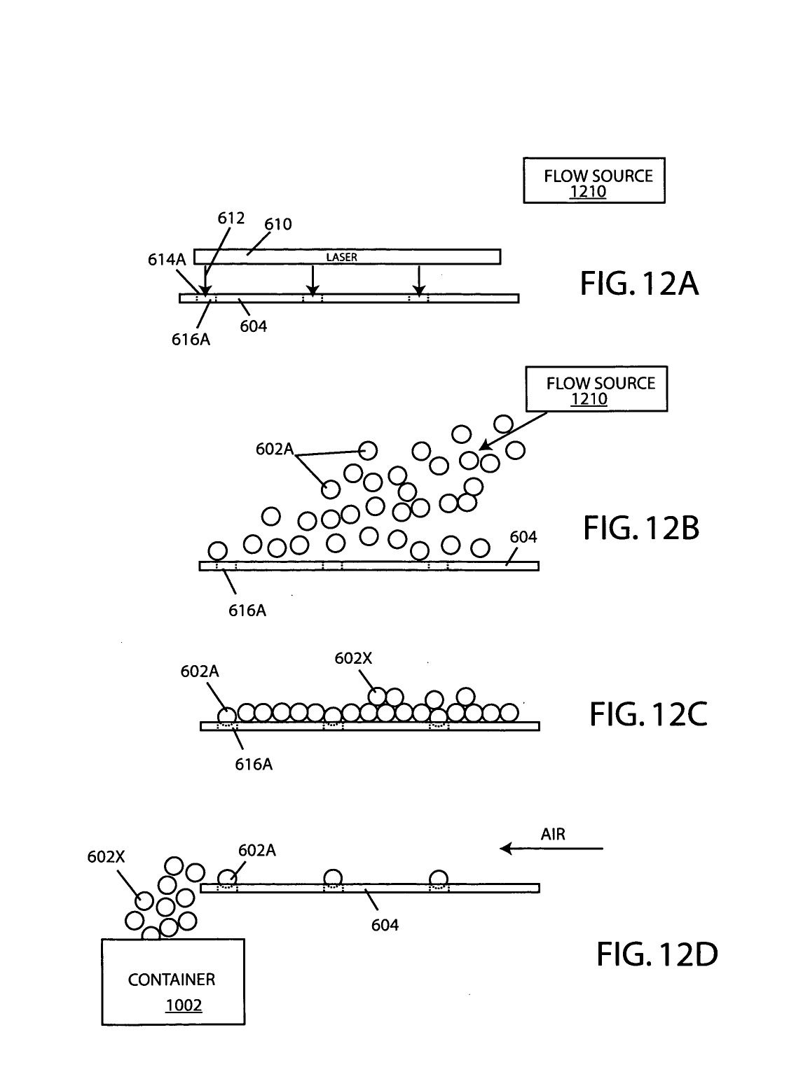

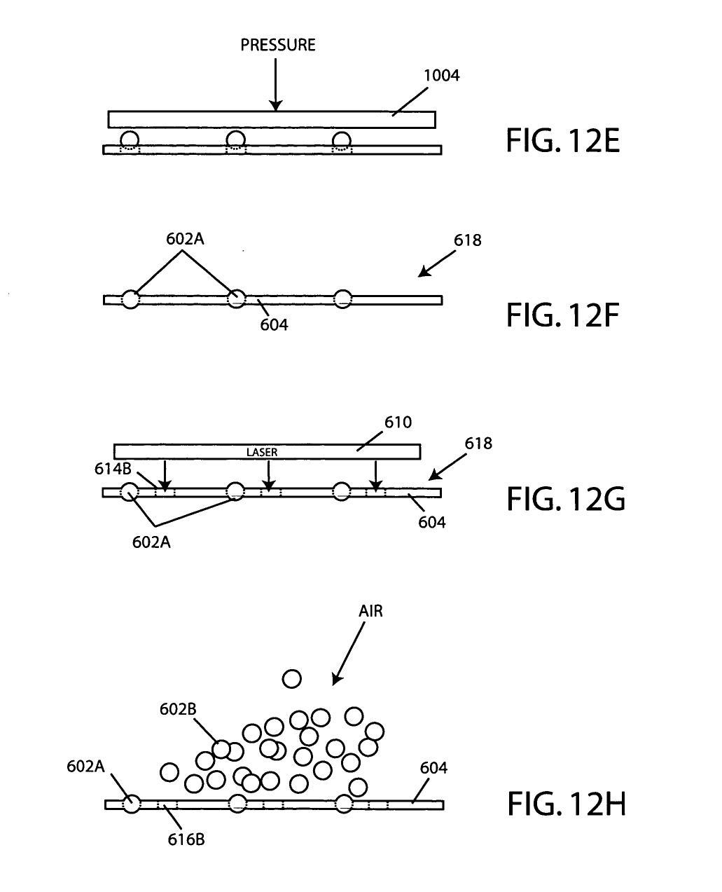

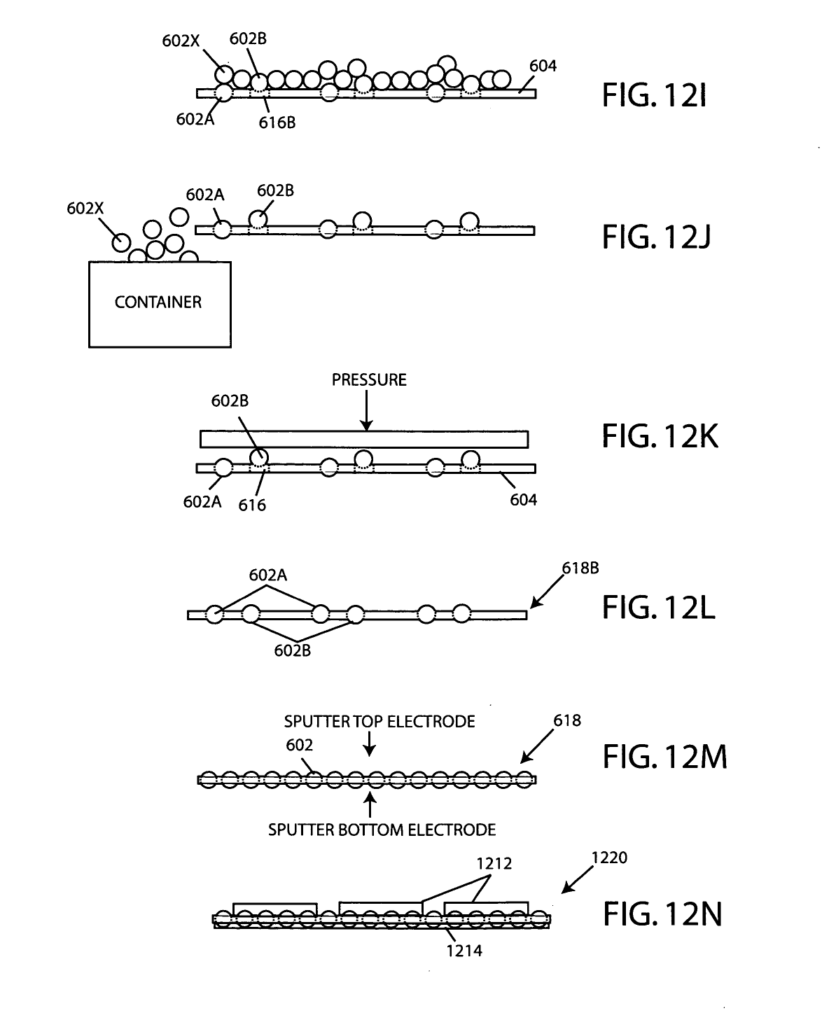

Loose wholly-coated EL particles 602 are then provided to the polymer substrate 604 (FIG. 10B). It is contemplated that the EL particles 602 may be provided by a variety of means, by way of example and not limitation by pouring the EL particles from a container, by carrying on a stream of air, or shaking from a vibration table. In this exemplary embodiment, EL particles 602 are poured from a container 1002 onto the polymer. As shown in FIG. 10B a large quantity of EL particles 602 may be provided to ensure that an EL particle 602 attaches to each of the molten receiving areas 616. As shown in FIG. 10C, the EL particles 602 that do not contact a molten area 616 are not attached to the polymer substrate 604. These excess EL particles 602 can be blown off or brushed off into a container 1002 for later use as shown in FIG. 10D. To ensure that the EL particles are positioned at a desired depth in the polymer substrate 604, a pressure may be applied to the EL particles 602 at block 930 of method 900 by a pressure plate 1004 (FIG. 10E) to achieve the EL apparatus 618A shown in FIG. 10F. In the embodiment shown in FIG. 10E, the pressure plate is in the form of the thermal print head 1010. It is contemplated that the removal of the excess of the EL particles 602 may occur before or after the application of pressure, as shown in block 940 of method 900. Because only specific target areas 614 have been heated so that molten EL particle receiving areas 616 are generated only in desired locations, EL particles 602 may be provided in a random fashion.

Whereas the exemplary method of FIGS. 10A-10F provided a random provision of EL particles 602 to the polymer, it is contemplated that specific arrangements of EL particles 602 within the polymer substrate 604 may be desired. FIG. 11 shows a method 1100 for embedding EL particles in a desired arrangement to form an EL apparatus 618 and an EL display using the system 1200 shown in FIG. 12A. At block 1110 a first group of target areas 614A is heated to generate first molten areas 616A as described above (FIG. 12A). At block 1120 a plurality of EL particles 602A having a desired first characteristic may be provided to the polymer substrate 604 (FIG. 12B) on a flow of fluid or other carrier from a flow source 1210. The EL particles 602A that contact the molten areas 616A attach to the polymer substrate 604 (FIG. 12C). As shown in FIG. 12D, at block 1130 EL particles 602X that do not adhere to the polymer substrate may be removed and collected. As shown in FIG. 12E, a pressure may be provided to embed the EL particles 602A to a desired depth in the polymer substrate 604 to form an EL apparatus 618.

The aforementioned process can then be repeated to incorporate additional EL particles 602B having a second desired characteristic, such as by way of example and not limitation, a particular phosphor color. At block 1140 a second set of target areas 614B may be heated (FIG. 12G) and EL particles 602B having the desired second characteristic provided at block 1150 (FIG. 12H). EL particles 602B that contact the molten areas 616B will adhere to the polymer substrate (FIG. 12I) and at block 1160 the EL particles 602X that do not adhere may be removed (FIG. 12J). Pressure may be applied to the adhered particles 602B to embed them to a desired depth (FIG. 12K) to form an EL apparatus 618B that includes EL particles 602B having the first desired characteristics and EL particles 602B having the second desired characteristic (FIG. 12L). This process can be repeated as many times as required to obtain an EL apparatus 618 (FIG. 12M) with the desired arrangement of EL particles 602. As shown in FIG. 12M-N at block 1170 top 1212 and bottom 1214 electrodes may be provided to the EL apparatus 618 to form an EL display 1220.

In the exemplary embodiments discussed herein a target area was shown of a size to incorporate a single EL particle 602. It is contemplated, however, that a target area 614 may be of various sizes and shapes so as to incorporate EL particles of different shapes and sizes and multiple EL particles if desired. For example, it is contemplated that the target area may be in the form of a strip or other shape to receive a line of EL particles 602.

The above-described and illustrated embodiments of the present invention are examples of implementations set forth for a clear understanding of the principles of the invention. Variations and modifications may be made to the above-described embodiments, and the embodiments may be combined, without departing from the scope of the following claims. It should be recognized that elements of the exemplary embodiments may be altered by persons skilled in the art without departing from the spirit and scope of the invention.

What is claimed is:

1. A method, comprising:
preparing at least one target area of a substrate to receive an electroluminescent (EL) particle; and
providing an EL particle to the at least one target area to form an EL apparatus.

2. The method of claim 1, wherein said preparing at least one target area of a substrate to receive an EL particle comprises locally heating the target area so that it becomes molten to form an EL particle receiving area.

3. The method of claim 1, wherein said preparing at least one target area of a substrate to receive an EL particle comprises exciting the target area with a laser.

4. The method of claim 1, further comprising preparing an EL particle.

5. The method of claim 4, wherein said preparing an EL particle comprises wholly coating a dielectric particle with a phosphor to form a wholly coated EL particle.

6. The method of claim 1, wherein said providing an EL particle to the at least one target area comprises providing the EL particle in a carrier tray.

7. The method of claim 1, wherein said providing at least one EL particle to the target area comprises providing a plurality of loose EL particles to the substrate.

8. The method of claim 1, wherein said providing an EL particle to the at least one target area comprises pouring at least one EL particle from a container onto said substrate.

9. The method of claim 1, wherein said providing an EL particle to the at least one target area comprises providing said EL particles on a flow carrier.

10. The method of claim 1, wherein said providing an EL particle to the at least one target area comprises providing a quantity of EL particles to the substrate in excess of the number of said at least one target areas.

11. The method of claim 10, further comprising removing EL particles from the substrate that are not in the at least one target area.

12. The method of claim 10, further comprising removing and collecting EL particles from the substrate that are not in the at least one target area.

13. The method of claim 1, further comprising applying pressure to said EL particle to embed the EL particle into the substrate to a predetermined depth.

14. The method of claim 1, further comprising, preparing a second target area to receive an EL particle.

15. The method of claim 14, further comprising providing an EL particle to said second target area.

16. The method of claim 1, further comprising depositing an upper electrode to the top of said EL apparatus and a lower electrode to the bottom said EL apparatus to form an EL display.

17. A system, comprising:
a substrate preparation device adapted to prepare a target area of a substrate to receive an electroluminescent (EL) particle; and
an EL particle carrier, adapted to provide an EL particle to the target area.

18. The system of claim 17, wherein said substrate preparation device comprises a laser source adapted to excite the target area to form an EL particle receiving area.

19. The system of claim 17, wherein said substrate preparation device comprises a thermal printhead.

20. The system of claim 17, wherein said EL particle carrier comprises a carrier tray.

21. The system of claim 17, wherein said EL particle carrier is a fluid flow.

22. The system of claim 17, wherein said EL particle carrier comprises a container adapted to hold EL particles.

23. A method, comprising:
providing a substrate;
heating a first target area of the substrate to form a first electroluminescent (EL) receiving area; and
providing at least one first EL particle to the first EL particle receiving area, said first EL particle having a first desired characteristic.

24. The method of claim 23, further comprising:
applying pressure to said first EL particle to embed the first EL particle in the substrate to a desired depth.

25. The method of claim 23, further comprising:
wherein said step of providing at least one first EL particle to the first EL receiving area comprises providing a plurality of EL particles to the substrate so that at least one EL particle attaches to the first EL particle receiving area.

26. The method of claim 25, further comprising removing EL particles that are not attached to a receiving area from the substrate.

27. The method of claim 23, further comprising:
heating a second target area of the substrate to form a second EL receiving area; and
providing a second EL particle to the second EL receiving area, said second EL particle having a second desired characteristic.
